(19) United States
(12) Patent Application Publication
(10) Pub. No.: US 2012/0265356 A1
(43) Pub. Date: Oct. 18, 2012

(54) POWER OUTPUT LEVELING METHOD AND APPARATUS FOR WIND TURBINE GENERATING FACILITY

(75) Inventor: Akira YASUGI, Tokyo (JP)

(73) Assignee: MITSUBISHI HEAVY INDUSTRIES, LTD., Tokyo (JP)

(21) Appl. No.: 13/178,921

(22) Filed: Jul. 8, 2011

Related U.S. Application Data
(63) Continuation of application No. PCT/JP2011/059231, filed on Apr. 14, 2011.

(51) Int. Cl. G05D 7/06

(52) U.S. Cl. 700/287

(57) ABSTRACT

It is intended to provide a method and an apparatus for leveling power output of a wind turbine generator facility as well as increasing power output. The power output leveling apparatus 4 includes a wind turbine controller 20 for controlling output of a wind turbine generator 2, a battery controller 30 for controlling an electrical storage device 3, and a master controller 40 for sending commands to the wind turbine controller 20 and the battery controller 30 respectively. The output of the wind turbine generator 2 is leveled by the power output leveling apparatus 4 to be adjusted to the target output.

### TECHNICAL FIELD

The present invention relates to a power output leveling method and a power output leveling apparatus for a wind turbine generator facility.

### BACKGROUND ART

There are a variety of methods for leveling the power output of the wind turbine generator facility, which fluctuates depending on a wind speed. For instance, Patent Literature 1 discloses a method for controlling the fluctuation in power output in a wind turbine generator facility when the power output of the wind turbine generator facility increases. The method of Patent Literature 1 includes the steps of increasing rotation speed of a rotor, storing surplus power output as rotation energy and performing pitch control such as not to exceed a prescribed rotation speed.

### CITATION LIST

### Patent Literature

### [PTL 1]

JP 11-082282A.

### SUMMARY OF INVENTION

### Technical Problem

In the wind turbine generator facility of Patent Literature the pitch control is performed to feather the blade so as to reduce the rotation speed. As a result, the wind energy that is available to be converted into electric power is partially lost and thus, it may be difficult to achieve a desired power output.

An electric power supplier supplies electric power produced in the wind turbine generator facility to consumers. The electric power supplier sets a target output in a set period of time. The profit of the electric power supplier depends on whether or not the target output is achieved. Therefore, a method of leveling power output as well as increasing power production, is desired.

it is an object of the present invention is provide power output leveling method and apparatus for a wind turbine generator, which can level the power output and increase power production as well.

### Solution to Problem

To solve the problems above, an aspect of the present invention is a power output leveling method for adjusting art output of a wind, turbine generator facility in which a wind turbine generator is combined with a secondary battery to a target output. The power output leveling method includes the steps of: measuring an output of the wind turbine generator; calculating a target-output achievement rate that is a rate of an integrated value of the measured outputs of the wind turbine generator from a starting point of a set period of time to a prescribed point within the set period of time with respect to a target output in the set period of time; and selecting an operation mode of the wind power facility. In the step of selecting the operation mode, when the target-output achievement rate is below a first threshold, a pitch-control invalid operation mode may be selected. In the pitch-control invalid operation mode a pitch control for leveling the output to reduce surplus output of the wind turbine generator with respect to the target, output is invalid and at least one of charging in the secondary battery and storing rotation energy of the wind turbine generator is performed.

The target output in the set period of time is, for instance, annual power production of an electric power supplier, which is produced by the wind turbine generator facility and supplied to consumers.

The prescribed point within the set period of time may be a midpoint or the end of the set period of time. For instance, monthly target outputs are set, “set period of time” being one month, “prescribed point within the set period of time” being a point which is one month past the starting point, and a monthly target-output achievement rate may be monitored repeatedly. Alternatively, annual target outputs are set, “set period of time” being one year, “prescribed point within the set period of time” being a point which is n month past the starting point (n is a natural number), and the target-output achievement, rate may be monitored repeatedly every n month.

in this manner, the target-output achievement rate is calculated based on the measured output of the wind turbine generator. When the target-output achievement rate is below the first threshold, the pitch control for leveling the output to reduce surplus output of the wind turbine generator with respect to the target output is invalid and at least one of charging in the secondary battery and storing rotation energy of the wind turbine generator is performed. Thus, the pitch control to feather the blades is performed less often. As a result, the amount of wind energy lost without being converted into electric energy is reduced, thereby generating more electrical energy.

The pitch angle herein refers to an angle formed between a blade chord and a rotor plane for rotation. When the blade angle is large, the wind passes through and the energy that the rotor extracts from the wind decreases. Thus, the pitch control to reduce surplus output of the wind turbine generator with respect to the target output refers to a pitch control to reduce the output of the wind turbine generator by increasing the pitch angle of the blade.

In the step of selecting the operation mode, when the target-output achievement rate is not less than the first threshold, a pitch-control permitted operation mode may be selected. In the pitch-control permitted operation mode, the pitch control is performed to reduce the surplus output of the wind turbine generator with respect to the target output.

In this manner, in the pitch-control permitted operation mode, the pitch control is permitted to reduce the surplus output of the wind turbine generator. Thus, depending on the state of the secondary battery, charging of the surplus output of the wind turbine generator into the secondary battery may be avoided and instead the pitch control may be performed to reduce the number of times of charging into the secondary battery, thereby extending the life of the secondary battery. Further, it is possible to reduce load on the secondary battery for leveling the power output and thus, inexpensive secondary battery with small capacity may be used.

When pitch-control permitted operation mode is selected in the operation mode selecting step, a step of calculating a loss rate is also provided. The loss rate is a rate of an amount of power loss due to the pitch control to an ideal output that is obtained based on a wind speed according to a performance curve of the wind turbine generator representing a relationship between the wind speed and the ideal output of the wind turbine generator. When the calculated loss rate is not less than a second threshold, the operation mode may be switched from the pitch-control permitted operation mode to the pitch-control invalid operation mode.

Even if the target-output achievement rate at a point is not less than the first threshold and there is comparatively sufficient power production, the wind speed and the wind direction changes and thus, it does not assure the power production can be kept positively after achieving the threshold once in order to achieve the target output. Therefore, when the loss rate is not less than the second threshold, even if the target-output achievement rate is not less than the first threshold and the pitch-control permitted operation mode is selected, the operation mode is switched to the pitch-control invalid mode, thereby performing the pitch control for reducing the surplus output, of the wind turbine generator less frequently. Thus, it is easy to achieve the target output in the set period of time.

The power curve of the wind turbine generator is a performance curve of the wind turbine generator representing a relationship between the wind speed and the ideal output of the wind turbine generator and is used to calculate the ideal output at the measured wind speed by applying the measured wind speed to the curve.

The power output leveling method further includes the step of obtaining a deterioration level of the secondary battery. When the obtained deterioration level of the secondary battery exceeds a third threshold, charging and discharging of the rotation energy of the wind turbine generator may be performed with higher priority than charging and discharging of the secondary battery, so as to reduce the surplus output or supply insufficient output with respect to the target output.

In this manner, the deterioration level of the secondary battery is obtained and the obtained deterioration level is compared with the third threshold that is set in advance. When the deterioration level exceeds the third threshold, storing or discharging of the rotation energy of the wind turbine generator is performed with higher priority than charging or discharging of the secondary battery so as to reduce the number of times that the secondary battery is charged. In this manner, it is possible to prevent the life of the secondary battery from decreasing. Further, it is possible to reduce load on the secondary battery for leveling the power output and thus, inexpensive secondary battery with small capacity may be used.

The deterioration level of the secondary battery may be at least one of the number of charge-discharge cycles, the number of total charge-discharge cycles and the number of charge-discharge rates.

The power output leveling method may also include a step of obtaining a remaining capacity of the secondary battery. When the obtained remaining capacity of the secondary battery is not in a set range, charging and discharging of the secondary battery may be performed with higher priority than charging and discharging of the rotation energy of the wind turbine generator, so as to reduce the surplus output or supply insufficient output with respect to the target output.

In this manner, the remaining capacity of the secondary battery is obtained and when the remaining capacity is not in the set range, charging and discharging of the secondary battery is performed with higher priority than charging and discharging of the rotation energy of the wind turbine generator so as to keep the remaining capacity in an adequate range. This prevents the life of the secondary battery from decreasing. Further, it is possible to maintain the remaining capacity within the prescribed range and thus, inexpensive secondary battery with small capacity can be used.

The power output leveling method also include a first target output modifying step of modifying the target output temporarily so as to reduce a difference between the output of the wind turbine generator and the target output, when the obtained deterioration level of the secondary battery exceeds the third threshold.

In this manner, when the obtained deterioration level of the secondary battery exceeds the third threshold, the target output is modified temporarily so as to reduce the difference between the output of the wind turbine generator and the target output. Thus, it is possible to sufficiently perform leveling of the power output more often by a method other than charging and discharging of the secondary batter (mainly by storing and discharging of the rotation energy of the wind turbine generator). As a result, it is possible to reduce the number of times that the secondary battery is charged or discharged, thereby extending the life of the secondary battery. Further, it is possible to reduce load on the secondary battery for leveling the power output and thus, inexpensive secondary battery with small capacity may be used.

The power output leveling method may also in clued a second target output modifying step of increasing the target output when the target-output achievement rate is less than the first threshold.

In this manner, the target output is increased so as to reduce the amount of wind energy lost without being converted into electric energy.

The power output leveling method may further include a step of obtaining a frequency of a grid to which the wind turbine generator and the secondary battery are connected, and a third target output modifying step of reducing the target output when the obtained frequency exceeds a set upper limit whereas increasing the target output, when the obtained frequency becomes less than a set lower limit.

In this manner, when the obtained frequency exceeds the set upper limit, the target output is reduced, thereby preventing the frequency of the grid from increasing. When the obtained frequency becomes lower than the lower limit of the set range, the target output is increased, thereby preventing the frequency of the grid from decreasing. Therefore, it is possible to control the frequency of the grid within the set range.

Another aspect of the present invention is a power output leveling apparatus of adjusting an output of a wind turbine generator facility in which a secondary battery is combined with a wind turbine generator to a target output. The power output leveling apparatus includes: an output measuring unit which measures an output of the wind turbine generator; a calculation unit which calculates a target-output achievement rate that is a rate of an integrated value of the measured outputs of the wind turbine generator from a starting point of a set period of time to a prescribed point within the set period of time with respect to a target output in the set period of time; and an operation mode selection unit which selects a pitch-control invalid operation mode when the target-output achievement rate is below a first threshold. In the pitch-control invalid operation mode, a pitch control for leveling the output to reduce surplus output of the wind turbine generator with respect to the target output is invalid and at least one of charging into the secondary battery and storing rotation energy of the wind turbine generator is performed.

According to the above power output leveling apparatus, the target-output achievement rate is calculated from the measured output of the wind turbine generator, and when the calculated target-output achievement rate is below the first threshold, the pitch control for leveling the output to reduce surplus output of the wind turbine generator with respect to the target output is invalid and at least one of charging into the secondary battery and storing rotation energy of the wind turbine generator is performed. Thus, the pitch control to feather the blades is performed less often. As a result, the amount of wind, energy lost without being converted into electric energy is reduced, thereby generating more electrical energy.

Another aspect of the present invention is a power output leveling method for adjusting an output of a wind turbine generator facility in which a secondary battery is combined with a wind turbine generator to a target output. The power output leveling method includes the steps of measuring an output of the wind turbine generator; calculating a loss rate that is a rate of an amount, of power loss due to the pitch control to an ideal output that is obtained based on a wind speed according to a performance curve of the wind turbine generator representing a relationship between the wind speed and the ideal output of the wind turbine generator; and selecting an operation mode of the wind power facility. In the step of selecting the operation mode, when the loss rate is below a second threshold, a pitch-control invalid operation mode is selected. In the pitch-control invalid operation, a pitch control for leveling the output to reduce surplus output of the wind turbine generator with respect to the target output is invalid and at least one of charging into the secondary battery and storing rotation energy of the wind turbine generator is performed.

According to the above power output leveling method, the loss rate is calculated from the measured output of the wind turbine generator and when the calculated loss rate is below the second threshold that is set in advance, the pitch control for leveling the output to reduce surplus output of the wind turbine generator with respect to the target output is invalid and at least one of charging into the secondary battery and storing rotation energy of the wind turbine generator is performed. Thus, the pitch control to feather the blades is performed less often. As a result, the amount of wind energy lost without being converted into electric energy is reduced, thereby generating more electrical energy.

### Advantageous Effects of Invention

According to the present invention, in order to reduce surplus output of the wind turbine generator with respect to the target output, when the target-output, achievement rate is below the first threshold, the pitch-control invalid operation mode is selected based on the target-output achievement rate or the loss rate. In the pitch-control invalid operation mode, a pitch control for leveling the output to reduce surplus output of the wind turbine generator with respect to the target output is invalid and at least one of charging in the secondary battery and storing rotation energy of the wind turbine, generator is performed. Thus, the pitch control to feather the blades is performed less often. As a result, the amount of wind energy lost without being converted into electric energy is reduced, thereby generating more electrical energy.

### BRIEF DESCRIPTION OF DRAWINGS

FIG. 1 illustrates an overall structure of a power output leveling apparatus for a wind turbine generator facility in relation to a first preferred embodiment of the present invention.

FIG. 2 is a control block diagram for reducing surplus output of the wind turbine generator when a pitch-control invalid operation mode is selected.

FIG. 3 is a control block diagram for supplying insufficient output of the wind turbine generator when the pitch-control invalid operation mode or a pitch-control permitted operation mode is selected.

FIG. 4 is a control block diagram for reducing surplus output of the wind turbine generator when the pitch-control permitted operation mode is selected.

FIG. 5 shows embodiments in which control is performed by an overall control unit of a master controller.

FIG. 6 is a control flow diagram showing a control flow of selecting the pitch-control invalid operation mode and the pitch-control permitted operation mode.

FIG. 7 is a control flow diagram showing a control by the overall control unit when the pitch-control invalid operation mode is selected.

FIG. 8 is a control flow diagram showing a control by the overall control unit when the pitch-control permitted operation mode is selected.

### DESCRIPTION OF EMBODIMENTS

A preferred embodiment of the present invention will now be described in detail with reference to the accompanying drawings. It is intended, however, that unless particularly specified, dimensions, materials, shape, its relative positions and the like shall be interpreted as illustrative only and not limitative of the scope of the present invention.

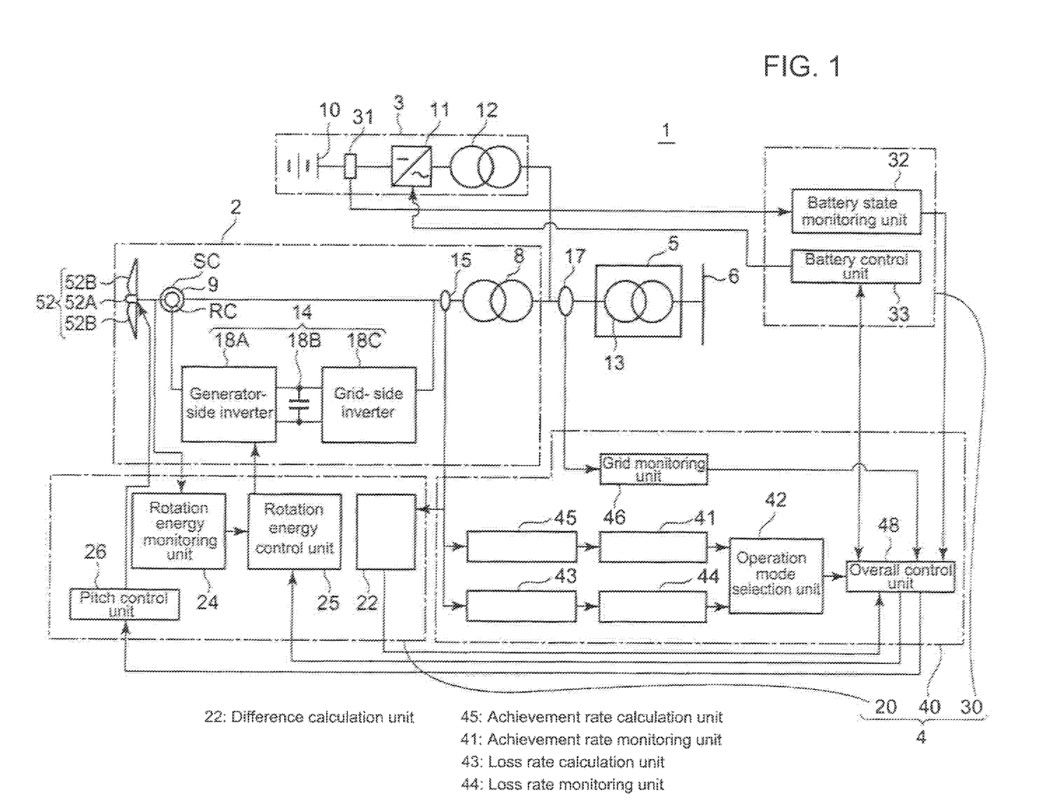

FIG. 1 illustrates an overall structure of a power output leveling apparatus for a wind turbine generator facility in relation to a first preferred embodiment of the present invention.

FIG. 1 shows the wind turbine generator facility 1 having a wind turbine generator 2, an electrical storage device 3 and a power output leveling apparatus 4. The wind turbine generator facility 1 is connected to a grid 6 via a grid interconnection part 5. The wind turbine generator 2 and the secondary battery are connected in parallel to the grid interconnection part 5.

The wind turbine generator 2 is a wind turbine system equipped with a so-called super-synchronous scherbius induction generator which is configured such that electric power produced by a generator 9 is available to be outputted to the grid 6 via an electric transformer 8 and a grid interconnection part 5 from both of a stator coil SC and a rotor coil RC. Specifically, the stator coil SC of the generator 9 is directly connected to the grid 6 and the rotor coil RC is connected to the grid 6 via an inverter unit 14. Although simplified in FIG. 1, an electric wire from the stator coil SC to the grid 6 and an electric wire from the rotor coil RC through the inverter unit 14 to the grid 6 are practically three-phase three-wire system.

A rotor 52 having blades 5213 installed to a hub 52A is coupled to the generator 9 via a gearbox (not shown). The rotation of the rotor 52 produced by wind power is inputted to the generator 9.

The inverter unit 14 includes a generator-side inverter 18A, a DC bus 18B and a grid-side inverter 18C. The inverter unit 14 converts AC power from the rotor coil RC into AC power compatible with a frequency of the grid 6. The generator-side inverter 38A converts the DC power generated in the rotor coil RC into DC power so as to output the AC power to the DC bus 18B. The grid-side inverter 18C controls voltage of the DC bus 1813 to perform supply and demand with the grid side. That is, the grid side inverter 18C converts the DC power from the DC bus 18B into the AC power of the same frequency as the grid 6, and outputs the AC power to the grid 6. The generator-side inverter 18A controls electric power outputted to the grid 6 from the generator 9.

FIG. 1 illustrates an exemplary case where the wind turbine generator 2 is a wind power turbine system equipped with the super-synchronous scherbius induction generator. However, this is not limitative and the wind turbine generator may be configured such that the generator is a heteropolar synchronous generator and the stator coil is connected to the grid via an inverter unit formed by an inverter and a converter.

The output of the wind turbine generator 2 can be adjusted by controlling a power transistor of the generator-side inverter 18A based on a control signal from a rotation energy control unit 25 of a wind turbine controller 20. The wind turbine controller 20 is described in details later.

For instance, in order to reduce the output of the wind turbine generator 2, the generator-side inverter 18A of the inverter unit 14 is controlled by the rotation energy control unit 25 to reduce one of torque and output of the generator, and the wind power acting on the blades 52B is converted into rotation energy of the wind turbine generator 2 and stored, thereby adjusting the output.

On the other, in order to increase the output of the wind turbine generator 2, the generator-side inverter 18A of the inverter unit 14 is controlled by the rotation energy control unit 25 to increase one of torque and output of the generator, and the rotation energy of the wind turbine generator 2 is converted into electric energy and recovered.

The electrical storage device 3 of the wind turbine generator facility 1 includes a secondary battery 10, a DC-AC converter 11, a transformer 12 and a battery condition detection unit 31.

The electrical storage device 3 converts AC power produced in the wind turbine generator 2 into DC power by the DC-AC converter 11 to store the DC power, converts discharged DC power into AC power by the DC-AC converter 11, and after the transformer 23 transforms the AC power to a prescribed voltage, the AC power is supplied to the grid 6 via the grid interconnection part 5.

The grid interconnection part 5 is provided to connect the wind turbine generator facility 1 to the grid 6. Based on conditions of grid interconnection between the grid interconnection part 5 and the grid 6, a variety of adjustment of supply power is performed. For instance, the grid interconnection conditions include a condition to set the voltage and fluctuation at an interconnection point within a permissible range. Further, the grid interconnection part 5 may include a transformer 13.

The grid 6 herein refers to a group of devices for supplying the power output produced in the power generating facility to consumers via an electric power cable and an electric power substation. In this embodiment, the grid 6 refers to a commercial power grid from which general consumers receive electric power.

The power output leveling apparatus 4 includes a wind turbine controller 20 which controls output of the wind turbine generator 2, a battery controller 30 which controls the electrical storage device 3, and a master controller 40 which gives commands to the wind turbine controller 20 and the battery controller 30 respectively. In the power output leveling apparatus 4, the output of the wind turbine generator 2 is leveled and adjusted to the target output. Each component of the power output leveling apparatus 4 is described in details below.

The master controller 40 includes an achievement rate calculation unit 45, an achievement rate monitoring unit 41, an operation mode selection unit 42, a loss rate calculation unit 43, a loss rate monitoring unit 44, a grid monitoring unit 46 and an overall control unit 48.

The achievement rate calculation unit 45 calculates an integrated value of measured outputs of the wind turbine generator 2 from a starting point of a set period of time to a prescribed point within the set period of time. The integrated value is divided by a target output in the set period of time to calculate a target-output achievement, rate.

The achievement rate monitoring unit 41 monitors constantly or periodically whether or not the target-output achievement rate calculated by the achievement rate calculation unit 45 is not less than a first threshold that is set in advance and the results is outputted to the operation mode selection unit 42.

The operation mode selection unit 42 selects one of a pitch-control invalid operation mode and a pitch-control permitted operation mode based on a signal from the achievement rate monitoring unit 41. Specifically, when the target-output achievement rate is below the first threshold, the pitch-control invalid operation mode is selected. In the pitch-control invalid operation mode, a pitch control for leveling the output to reduce surplus output of the wind turbine generator 2 with respect to the target output is invalid and at least one of charging of the secondary battery 10 and storing of rotation energy of the wind turbine generator 2 is performed. When the target-output achievement rate is not less than the first threshold, the pitch-control permitted operation mode is selected. In the pitch-control permitted operation mode, the pitch control is performed to reduce the surplus output of the wind turbine generator 2 with respect to the target output.

The loss rate calculation unit 43 calculates a loss rate by dividing an amount of power loss due to the pitch control by an ideal output obtained based on a wind speed according to a power curve of the wind turbine generator 2, and the calculation result is outputted to the loss rate monitoring unit 44. The amount of power loss due to the pitch control can be obtained as a difference between an actual output obtained from the measured output of the wind turbine generator 2 measured by an output measuring unit 15 and the ideal output. The amount of power loss is the amount of wind energy that was available for power generation but lost due to the pitch control.

The loss rate monitoring unit 44 constantly or periodically monitors whether or not the loss rate calculated by the loss rate calculation unit 43 is not less than a second threshold that is set in advance and the monitoring result is outputted to the operation mode selection unit 42. Based on the signal outputted from the loss rate monitoring unit 44, the operation mode selection unit 42 switches the operation mode from the pitch-control permitted mode to the pitch-control invalid mode. Specifically, when the calculated loss rate is not less than the second threshold, the operation mode is switched from the pitch-control permitted operation mode to the pitch-control invalid operation mode even during the operation in the pitch-control permitted operation mode so as to reduce the surplus output of the wind turbine generator 2 with respect to the target output by a method other than the pitch control.

The overall control unit 48 sends a control signal to a pitch control unit 26 of the wind turbine controller 20 and to a battery control unit 33 of a battery controller 30 in accordance with the selected operation mode selected by the operation mode selection unit 42.

The grid monitoring unit 46 receives a grid frequency of the grid 6 measured by a sensor 17, monitors a state of the grid 6 and outputs the monitoring result t the overall control unit 48. The overall control unit 48 reduces the target output temporarily when the grid frequency of the grid 6 exceeds an upper limit of the prescribed range, whereas temporarily increases the target output of the wind turbine generator facility 1 when the grid frequency of the grid 6 becomes below a lower limit of the prescribed range. In this manner, the frequency of the grid 6 is kept with the prescribed range.

The wind turbine controller 20 includes a difference calculation unit 22, a rotation energy monitoring unit 24, a rotation energy control unit 25 and a pitch control unit 26.

The difference calculation unit 22 calculates a difference between the measured output of the wind turbine generator 2 measured by the output measuring unit 15 and the target output set in advance, and outputs the calculation result to the overall control unit 48 of the master controller 40.

The rotation energy monitoring unit 24 monitors constantly or periodically an amount of rotation energy (inertial energy) stored when the rotation speed of the rotor 52 increases.

The rotation energy control unit 25 changes torque of the generator by controlling the generator-side inverter 18A based on the control signal from the overall control unit 48 of the master controller 40, thereby performing control for converting the surplus output of the wind turbine generator 2 to rotation energy or recovering the rotation energy as electrical energy of the wind turbine generator 2.

The pitch control unit 26 adjusts pitch angle of the blades 52B based on the control signal from the overall control unit 48 of the master controller 40 to reduce the difference between the output of the wind turbine generator 2 and the target output to perform the pitch control.

The battery controller 30 includes the battery state monitoring unit 32 and the battery control unit 33.

The battery state monitoring unit 32 receives detection result on a deterioration level of the secondary battery 10 from the battery state detection unit 31 connected to the secondary battery 10 and monitors the state of the secondary batter 10. The monitoring result of the state of the secondary battery 10 from the battery state monitoring unit 32 is sent to the overall control unit 48 of the master controller 40. Based on the monitoring result, it is determined whether or not charging and discharging of the secondary battery 10 is performed with higher priority to reduce the difference between the output of the wind turbine generator and the target output.

As an indicator of the deterioration level, at least one of the number of charge-discharge cycles, the number of total charge-discharge cycles and the number of charge-discharge rates is used.

In the preferred embodiment, the number of charge-discharge cycles refers to the number of charge-discharge cycles in a set period of time that is set in advance. Each cycle is from charging to discharging of the secondary battery 10. The number of total charge-discharge cycles is the total number of charge-discharge cycles from a starting point of using the secondary battery 10 to a prescribed point. The number of charge-discharge rates is the number of times an amount of charge-discharge exceeds a prescribed threshold in unit time.

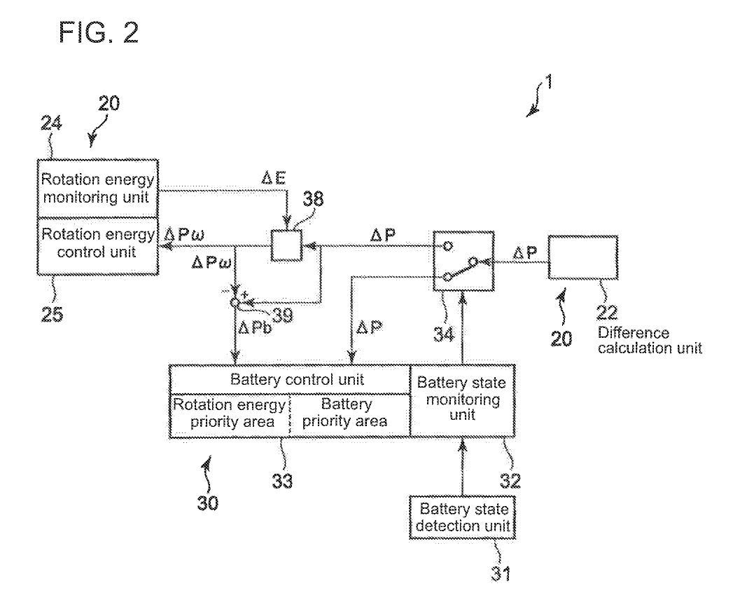

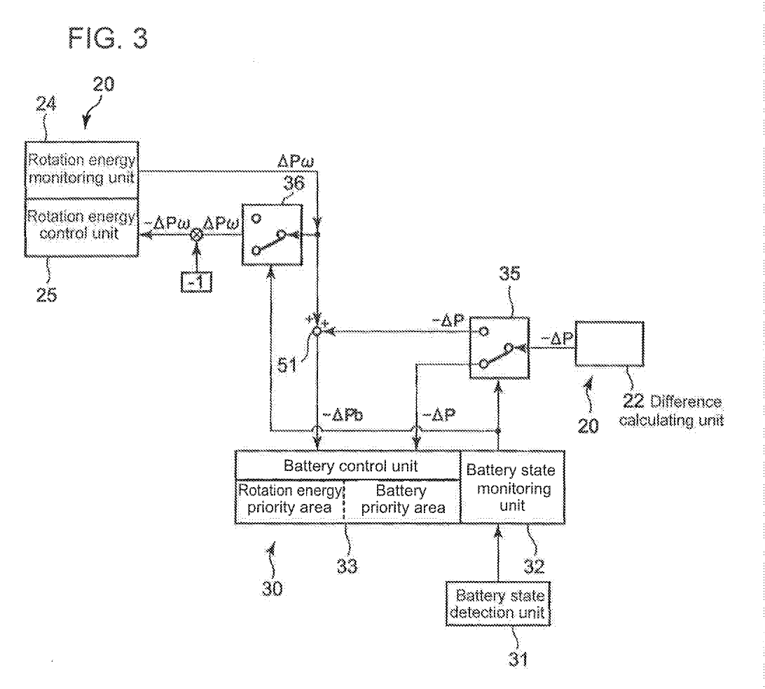

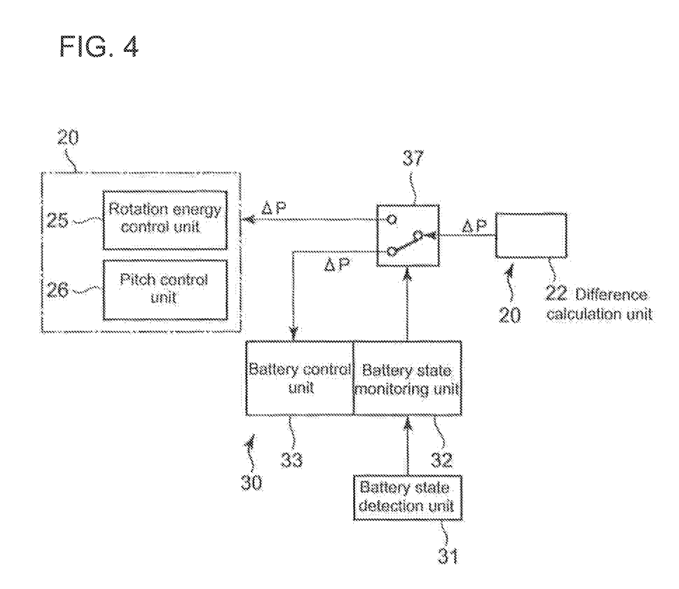

FIG. 2 to FIG. 4 are used to explain signals transmitted between each component when the power output leveling apparatus 4 performs such control to level the output. FIG. 2 is a control block diagram for reducing surplus output of the wind turbine generator 2 when the pitch-control invalid operation mode is selected. FIG. 3 is a control block diagram for supplying insufficient output of the wind turbine generator 2 when one of the pitch-control invalid operation mode and a pitch-control permitted operation mode is selected. FIG. 4 is a control block diagram for reducing surplus output of the wind turbine generator 2 when the pitch-control permitted operation mode is selected.

[symbol] To Reduce Surplus Output of the Wind Turbine Generator when the Pitch-Control Invalid Operation Mode is Selected

[symbol]

As shown in FIG. 2, the difference calculation unit 22 of the wind turbine controller 20 calculates a difference Δ P (>0) between the output of the wind turbine generator 2 and the target output. The difference Δ P is sent to a first switch 34 which is a part of the overall control unit 18 of the master controller 40. The battery state monitoring unit 32 monitors constantly or periodically whether or not the deterioration level of the secondary battery detected by the battery state detection unit 31 is below a third threshold, and sends the monitoring result to the first switch 34. Based on the signal from the battery state monitoring unit 32, the first switch 34 selects which one of charging into the secondary battery 10 and storing the rotation energy of the wind turbine generator 2 is performed with higher priority in order to reduce the surplus output Δ P of the wind turbine generator 2.

Specifically, when the deterioration level is below the third threshold, in order to reduce the surplus output of the wind turbine generator 2 with respect to the target output, the first switch 31 is connected to a lower connection terminal on a lower side of FIG. 2 (secondary battery side) to perform charging of the secondary battery with higher priority than storing the rotation energy. When the deterioration level is not less than the third threshold, in order to reduce the surplus output of the wind turbine generator 2 with respect to the target output, the first switch 34 is connected to an upper connection terminal on an upper side of FIG. 2 (rotation energy side) to perform storing of the rotation energy with higher priority than charging of the secondary battery.

When the first switch 34 is connected to the lower connection terminal, the difference Δ P outputted from the difference calculation unit 22 of the wind turbine controller 20, is inputted to a battery priority area of the battery control unit 33 via the first switch 34.

In contrast, when the first switch 34 is connected to the upper connection terminal of FIG. 2, the difference Δ P is outputted to a comparison unit 38 and a subtractor 39 via the first switch 34.

The rotation energy monitoring unit 24 calculates a surplus amount of stored rotation energy Δ E which is a difference between a maximum amount of rotation energy that can be stored in the wind turbine generator 2 and a current amount of rotation energy E that is currently saved in the wind turbine generator 2, and outputs the surplus amount of stored rotation energy Δ E to an comparison unit 38.

The comparison unit 38 calculates an amount of command rotation energy Δ P a of the wind turbine generator 2 based on comparison result of comparing the difference Δ P and the surplus amount Δ E of stored rotation energy. Specifically, the comparison unit 38 calculates Δ Pω as Δ Pω=Δ E when Δ P>Δ E, and Δ Pω=Δ P when Δ P≦Δ E. The amount of command rotation energy, Δ Pω from the comparison unit 38 is then outputted to the rotation energy control unit 25 and the subtractor 39.

In the rotation energy control unit 25, the generator-side inverter 18A (see FIG. 1) is controlled based on the amount of command rotation energy, Δ Pω to reduce the torque and the output of the generator, and wind power acting on the blades 52B is converted into rotation energy of the wind turbine generator 2 to store surplus output, thereby leveling the output.

The subtractor 39 subtracts the amount of command rotation energy Δ Pω outputted from the comparison unit 38 from the difference, Δ P outputted from the difference calculation unit 22 via the first switch 34. When Δ P−Δ Pω (amount of convertible command rotation energy) is positive. i.e. Δ P>Δ Pω, a charge command amount Δ Pb (=Δ P−Δ Pω) is outputted to the battery priority area of the battery control unit 33. In contrast, when Δ P−Δ Pω is negative, i.e. Δ P<Δ Pω, it is deemed that the surplus output is solved by storing the rotation energy and thus, the charge command amount Δ Pb (=Δ P−Δ Pω) outputted to the battery priority area of the battery control unit 33 is zero.

[symbol] To Supply Insufficient Output of the Wind Turbine Generator 2 when One of the Pitch-Control Invalid Operation Mode and the Pitch-Permitted Operation Mode is Selected

[symbol]

As shown in FIG. 3, first, the difference calculation unit 22 of the wind turbine controller 20 calculates the difference −Δ P (<0) between the output of the wind turbine generator 2 and the target output. The difference −Δ P is sent to a second switch 35 which is a part of the overall control unit 48 of the master controller 40. Further, the battery state monitoring unit 32 monitors constantly or periodically whether or not the deterioration level of the secondary battery 10 detected by the battery state detection unit 31 is below the third threshold, and sends the monitoring result to the second switches 35 and 36. Based on the signal from the battery state monitoring unit 32, the second switches 35 and 36 select which one of discharging from the secondary battery 10 and discharging the rotation energy of the wind turbine generator 2 is performed with higher priority in order to supply the insufficient amount −Δ P of the wind turbine generator 2.

Specifically, when the deterioration level is below the third threshold, in order to supply the insufficient output of the wind turbine generator 2 with respect to the target output, the second switches 35 and 36 are connected to a lower connection terminal on a lower side of FIG. 3 (secondary battery side) to perform discharging of the secondary battery 10 with higher priority than recovering the rotation energy. In contrast, when the deterioration level is not less than the third threshold, in order to supply the insufficient output of the wind turbine generator 2 with respect, to the target output, the second switches 35 and 36 are connected to a upper connection terminal on an upper side of FIG. 3 (rotation energy side) to perform recovering the rotation energy with higher priority than discharging of the secondary battery.

When the second switch 35 is connected to the lower connection terminal (secondary battery side), the difference −Δ P that is outputted from the difference calculation unit 22 of the wind turbine controller 20, is inputted to the battery priority area of the battery control unit 33. When the second switch 36 is connected to the lower connection terminal, an energy discharge command of discharging rotation energy is not outputted to the rotation energy control unit 25. Therefore, the amount of the insufficient output −Δ P of the wind turbine generator 2 is discharged from the secondary battery 10.

In contrast, when the second switch 35 is connected to the upper connection terminal (rotation energy side), the difference −Δ P is outputted to an adder 51. The rotation energy monitoring unit 24 obtains a current amount of stored rotation energy, Δ Pω of the wind turbine generator 2. The current amount of stored rotation energy Δ Pω of the wind turbine generator 2 is also inputted to the adder 51. Then, the adder 51 obtains −Δ Pb from the sum of the difference −Δ P and the current amount of stored rotation energy Δ Pω. The sum −Δ P b is inputted to the rotation energy priority area of the battery control unit 33 as a battery discharge command amount. On the other hand, when the second switch 36 is connected to the upper connection terminal (rotation energy side), the amount of stored rotation energy Δ Pω is sent from the rotation energy monitoring unit 24 via the second switch 36 to the rotation energy control unit 25. In such process, the amount of stored rotation energy Δ Pω is multiplied by −1 to change plus to change plus and minus sign, and the amount of stored rotation energy Δ Pω becomes, an energy discharge corn mend amount −Δ Pω of discharging the rotation energy and is inputted to the rotation energy control unit 25.

In the rotation energy control unit 25, the generator-side inverter 18A (see FIG. 1) is controlled based on the energy discharge command amount −Δ Pω to increase torque or output of the generator, and the rotation energy stored in the rotor 52 is recovered to convert into electric energy, thereby solving insufficient output and also leveling output.

When the slim obtained in the adder 51 is positive, i.e. Δ Pω>Δ P, it is deemed that the insufficient output is supplied by recovering the rotation energy. Therefore, the battery discharge command amount −Δ Pb outputted to a rotation energy priority area of the battery control unit 33 is zero.

[symbol] To Reduce Surplus Output of the Wind Turbine Generator when the Pitch-Control Permitted Operation Mode is Selected

[symbol]

As shown in FIG. 4, first, the difference calculation unit 22 of the wind turbine controller 20 calculates the difference Δ P (>0) between the output of the wind turbine generator 2 and the target output. The difference Δ P is sent to a third switch 36 which is a part of the overall control unit 48 of the master controller 40. Further, the battery state monitoring unit 32 monitors constantly or periodically whether or not the deterioration level of the secondary battery 10 detected by the battery state detection unit 31 is below the third threshold, and sends the monitoring result to the third switch 37. Based on the signal from the battery state monitoring unit 32, the third switch 37 selects which one of charging of the secondary battery 10 and storing the rotation energy of the wind turbine generator 2 together with pitch control is performed with higher priority in order to reduce the surplus output Δ P of the wind turbine generator 2.

Specifically, when the deterioration level is below the third threshold, in order to reduce the surplus output Δ P with respect to the target output, the third switch 37 is connected to a lower connection terminal on a lower side of FIG. 4 (secondary battery side) to perform charging of the secondary battery 10 with higher priority. In contrast, when the deterioration level is not less than the third threshold, in order to reduce the surplus output Δ P with respect to the target output, the third switch 37 is connected to an upper connection terminal on an upper side of FIG. 4 (rotation energy side) to perform at least one of storing of the rotation energy and the pitch control. In such case, from the perspective of improving power output of the wind turbine generator facility 1, the rotation energy is stored with higher priority than the pitch control. However, if there is still surplus output after storing the rotation energy, the pitch control may be performed for the remaining amount of the surplus output of the wind turbine generator 2 to reduce the surplus output.

When the third switch 37 is connected to the lower connection terminal of FIG. 4, the difference Δ P outputted from the difference calculation unit 22 of the wind turbine controller 20 is outputted to the battery control unit 33 as the charge command amount.

In contrast, when the third switch 37 is connected to the upper connection terminal of FIG. 4, the difference Δ P is outputted to the wind turbine controller 20.

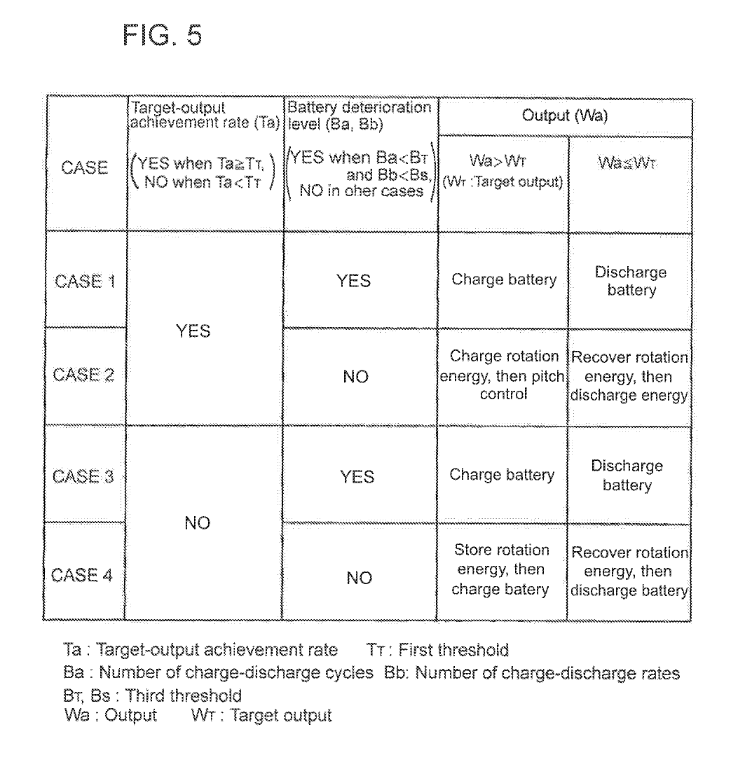

FIG. 5 shows embodiments in which control is performed by the overall control unit 48 of the master controller 40 described above.

As shown in FIG. 5, the integrated value of measured outputs of the wind turbine generator 2 from a starting point of a set period of time to a prescribed point of within the set period of time is calculated and then, the integrated value is divided by a target output in the set period of time to calculate a target-output achievement rate Ta.

[symbol] Case 1

[symbol]

When the target-output achievement rate Ta is not less than the first threshold T_{T} of the target-cutout achievement rate that is set in advance (YES in a section of the target-output achievement rate Ta), and both of a deterioration level Ba (in accordance with the number of charge-discharge cycles as an indicator) and a deterioration level Bb (in accordance with the number of charge-discharge rates as an indicator) are below third thresholds B_{T} and B_{S} respectively that are set beforehand (YES in a section of the battery deterioration level Ba, Bb), the secondary battery 10 is discharge or charged.

Specifically, when the output Wa of the wind turbine generator 2 exceeds the target output W_{T}, the third switch 37 is connected to the lower connection terminal (secondary battery side) of FIG. 4 to input the difference Δ P from the difference calculation unit 22 to the battery priority area of the battery control unit 33 via the third switch 37. When the output Wa of the wind turbine generator 2 is not greater than the target output W_{T}, the second switch 35 is connected to the lower connection terminal (secondary battery side) of FIG. 3 to input the difference −Δ P from the difference calculation unit 22 to the battery priority area of the battery control unit 33 via the second switch 35.

[symbol] Case 2

[symbol]

When the target-output achievement rate Ta is not less than the first threshold T_{T} (YES in the section of the target-output achievement rate Ta), and at least one of the deterioration level Ba and the deterioration level is not less than the third thresholds B_{T} and B_{S} respectively (NO in the section of the battery deterioration level Ba, Bb), the rotation energy is stored and recovered first. Further, in the case where the output Wa of the wind turbine generator 2 exceeds the target output W_{T}, if there is still surplus output after storing the rotation energy, the pitch control is performed, whereas in the case where the output. Wa of the wind turbine generator 2 is not greater than the target output W_{T}, if there is still insufficient output after recovering the rotation energy, the secondary battery 10 is discharged.

Specifically, when the output Wa of the wind turbine generator 2 exceeds the target output W_{T}, the third switch 37 is connected to the upper connection terminal (rotation energy side) of FIG. 4 to input the difference Δ P from the difference calculation unit 22 to the wind turbine controller 20 via the third switch 37. When the output Wa of the wind turbine generator 2 is not greater than the target output W_{T}, the second switch 35, 36 is connected to the upper connection terminal (rotation energy side) of FIG. 3 to input the energy discharge command amount −Δ Pω to the rotation energy control unit 21 and also input the battery discharge command amount Δ P to the rotation energy priority area of the battery control unit 33.

[symbol] Case 3

[symbol]

When the target-output achievement rate Ta is below the first threshold T_{T} (NO in the section of the target-output achievement rate Ta), and both of the deterioration level Ba and the deterioration level Bb are below the third thresholds B_{T} and B_{S} (YES in the section of the battery deterioration level Ba, Bb), the secondary battery 10 is charged or discharged.

Specifically, when the output Wa of the wind turbine generator 2 exceeds the target output W_{T}, the first switch 34 is connected to the lower connection terminal (secondary battery side) of FIG. 2 to input the difference Δ P from the difference calculation unit 22 to the battery priority area of the battery control unit 33 via the first switch 34. When the output Wa of the wind turbine generator 2 is not greater than the target output W_{T}, the second switch 35 is connected to the lower connection terminal (secondary batter side) of FIG. 3 to input the difference −Δ P outputted from the difference calculation unit 22 to the battery priority area of the battery control unit 33.

[symbol] Case 4

[symbol]

When the target-output achievement rate Ta is below the first threshold T_{T} (NO in the section of the target-output achievement rate Ta), and at least one of the deterioration level Ba and the deterioration level Bb is not less than the third thresholds B_{T} and B_{S} respectively (NO in the section of the battery deterioration level Ba, Bb), the rotation energy is stored and recovered with higher priority. Then, in the case where the output Wa of the wind turbine generator 2 exceeds the target output W_{T}, if there is still surplus output after storing the rotation energy, the secondary battery is charged, whereas in the case where the output Wa of the wind turbine generator 2 is not greater than the target output W_{T}, if there is still insufficient output after recovering the rotation energy, the secondary battery 10 is discharged.

Specifically, when the output Wa of the wind turbine generator 2 exceeds the target output W_{T}, the first switch 34 is connected to the upper connection terminal (rotation energy side) of FIG. 2 to input the store command amount Δ Pω to the rotation, energy control unit 25 and also input the charge command amount Δ Pb to the rotation energy priority area of the battery control unit 33, in contrast, when the output Wa of the wind turbine generator 2 is not greater than the target output W_{T}, the second switch 35, 36 is connected to the upper connection terminal (rotation energy side) of FIG. 3 to input, the energy discharge command amount −Δ Pω to the rotation energy control unit 25 and also input the battery discharge command amount −Δ P b to the rotation energy priority area of the battery control unit 33

Next, control flows performed in the power output leveling apparatus 4 are explained in reference to the flow charts.

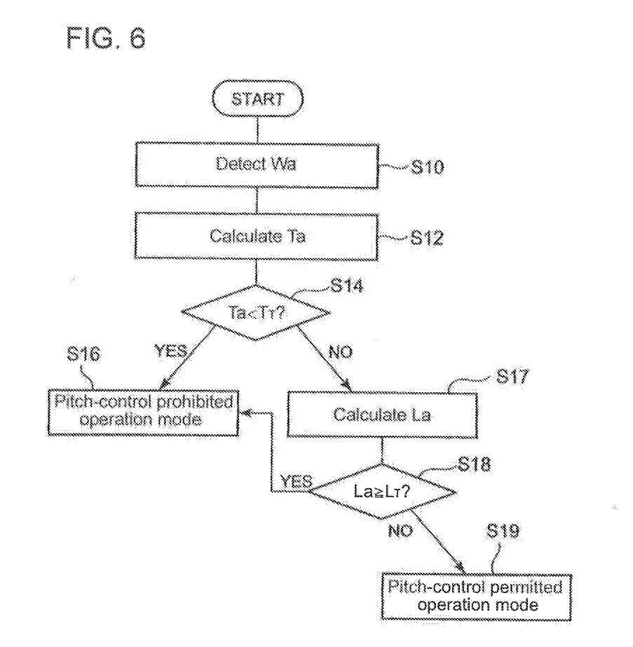

FIG. 6 is a control flow diagram showing a control flow of selecting the pitch-control invalid operation mode and the pitch-control permitted operation mode.

As shown in FIG. 6, the output measuring unit 15 measures a current output Wa of the wind turbine generator 2 (Step S10).

Based on the measured output Wa, an integrated value of the measured outputs of the wind turbine generator 2 from a starting point of a set period of time to a prescribed point within the set period of time and divide the integrated value is divided by a target output in the set period of time by the achievement rate calculation unit 45 to calculate the target-output achievement rate Ta (Step S12).

Next, the calculated target-output achievement rate Ta is compared with the first threshold T_{T} in the achievement rate monitoring unit 41 and the comparison result is sent to the operation mode selection unit 42 (Step S14).

When the calculated target-output achievement rate Ta is below the first threshold T_{T} (YES in S14), the operation mode selection unit 42 selects the pitch-control invalid operation mode which invalidates the pitch control (Step S16). Subsequently, the overall control unit 48 controls the rotation energy control unit 25 and the battery control unit 33 so as to operate in the pitch-control invalid operation mode.

On the other, when the calculated target-output achievement rate Ta is not less than the first threshold T_{T} (NO in S14), the loss rate calculation unit 43 calculates a loss rate La (an amount of power production lost due to the pitch control) which is a rate of the actual production amount obtained from the measured output Wa measured by the output measuring unit 15 to an ideal output (Step S. Then, the calculated loss rate La is compared with a second threshold L_{T} of a loss rate that is set in advance and the comparison result is sent to the operation mode selection unit 42. When the loss rate La is not less than the second threshold L_{T} (YES in S18), the process advances to the step S16 so that the operation-mode selection unit 42 selects the pitch-control invalid operation mode.

When the loss rate La is below the second threshold L_{T} (NO in S18), the process advances to a step S19 so that the operation-mode selection unit 42 selects the pitch-control permitted operation mode to allow the pitch control (Step S19). Subsequently, the overall control unit 48 controls the rotation energy control unit 25, the pitch control unit 26 and the battery control unit 33 so as to operate in the pitch-control permitted operation mode.

Now, control flows performed by the overall control unit 48 after the operation mode selection unit 42 selects the pitch-control invalid operation mode are explained below.

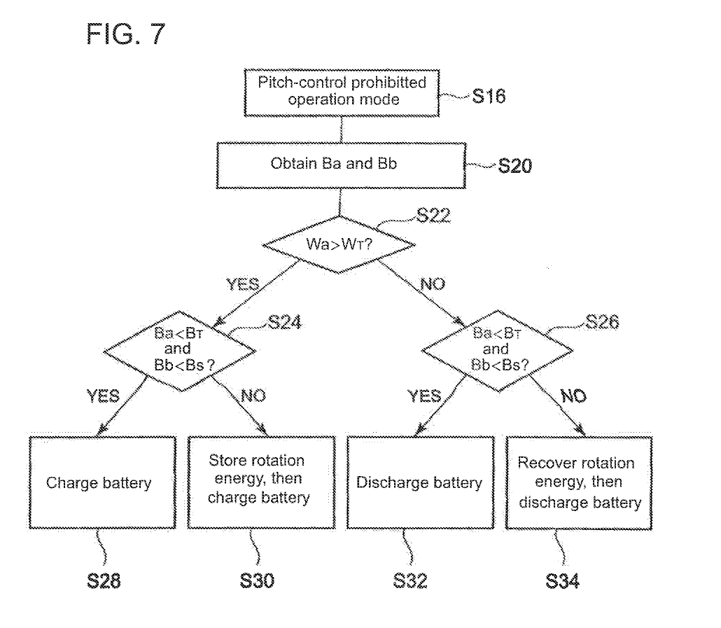

FIG. 7 is a control flow diagram showing a control by the overall control unit 48 when the pitch-control invalid operation mode is selected.

As shown in FIG. 7, when the pitch-control invalid operation mode is selected (Step S16), the battery state detection unit 31 obtains the deterioration level of the secondary battery 10, e.g. the number of charge-discharge cycles, Ba and the number of charge-discharge rates, Bb (Step S20) and outputs the obtained result to the battery state monitoring unit 32.

Further, in the pitch-control invalid operation mode only invalidates the pitch control for leveling the power output and does not invalidate a pitch control itself.

The difference calculation unit 22 determines whether or not the output Wa of the wind turbine generator 2 measured by the output measuring unit 15 exceeds the target output W_{T} (Step S22).

Then, the battery state monitoring unit 32 determines whether or not both of the deterioration levels Ba and Bb inputted from the battery state detection unit 31 are below the third thresholds B_{T} and B_{S} (Step S24 and Step S26).

When it is determined in the step S22 that the output Wa of the wind turbine generator 2 exceeds the target output W_{T} and it is determined in the step S24 that both of the deterioration levels Ba and Bb inputted from the battery state detection unit 31 are below the third thresholds B_{T} and B_{S}, the process advances to a step S28 to charge the secondary battery 10 under the control by the overall control unit 48. Such control corresponds to Wa<W_{T} of Case 3 in FIG. 5 that is described above.

When it is determined in the step S22 that the output Wa of the wind turbine generator 2 exceeds the target output W_{T} and it is determined in the step S24 that at least one of the deterioration levels Ba and Bb inputted from the battery state detection unit 31 is not less than the third thresholds B_{T} and B_{S}, the process advances to a step S30 to store the rotation energy with higher priority under the control by the overall control unit 48. If there is still surplus output after storing the rotation energy, charging of the secondary battery 10 is performed. Such control corresponds to Wa>W_{T} of Case 4 in FIG. 5 that is described above.

When it is determined in the step S22 that the output Wa of the wind turbine generator 2 is not greater than the target output W_{T} and it is determined in the step S26 that both of the deterioration levels Ba and Bb are below the third thresholds B_{T} and B_{S}, the process advances to a step S32 to discharge from the secondary battery 10 under the control by the overall control unit 48. Such control corresponds to Wa W_{T} of Case 3 in FIG. 5 that is described above.

When it is determined in the step S22 that the output Wa of the wind turbine generator 2 is not greater than the target output W_{T} and it is determined in the step S26 that at least one of the deterioration levels Ba and Bb is not less that the third thresholds B_{T} and B_{S}, the process advances to a step S34 to perform recovering of the rotation energy with higher priority under the control by the overall control unit 48. Such control corresponds to Wa≦W_{T} of Case 4 in FIG. 5 that is described above.

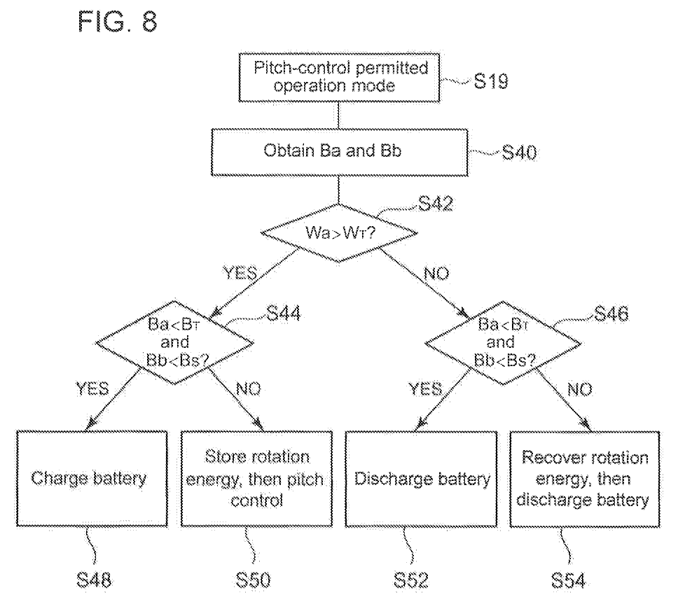

FIG. 8 is a control flow diagram showing a control by the overall control unit 48 when the pitch-control permitted operation mode is selected.

As shown in FIG. 8, when the pitch-control permitted operation mode is selected (Step S19), the battery state detection unit 31 obtains the deterioration levels Ba and Bb of the secondary battery 10, e.g. Ba: the number of charge-discharge cycles and Bb: the number of charge-discharge rates (Step S40) and outputs the obtained result to the battery state monitoring unit 32.

The difference calculation unit 22 determines whether or not the output Wa of the wind turbine generator 2 measured by the output measuring unit 15 exceeds the target output W_{T} (Step S42).

Then, the battery state monitoring unit 32 determines whether or not both of the deterioration levels Ba and Bb inputted from the battery state detection unit 31 are below the third thresholds B_{T} and B_{S} (Step S44 and Step S46).

When it is determined in the step S42 that the output Wa of the wind turbine generator 2 exceeds the target output W_{T} and it is determined in the step S44 that both of the deterioration levels Ba and Bb inputted from the battery state detection unit 31 are below the third thresholds B_{T} and B_{S}, the process advances to a step S48 to charge the secondary battery 10 under the control by the overall control unit 48. Such control corresponds to Wa>W_{T} of Case 1 in FIG. 5 that is described above.

When it is determined in the step S42 that the output Wa of the wind turbine generator 2 exceeds the target output W_{T} and it is determined in the step S44 that at least one of the deterioration levels Ba and Bb inputted from the battery state detection unit 31 is not less than the third thresholds B_{T} and B_{S}, the process advances to a step S50 to store the rotation energy with higher priority under the control by the overall control unit 48. Only when there is still surplus output after storing the rotation energy, the pitch control is performed. Such control corresponds to Wa<W_{T} of Case 2 in FIG. 5 that is described above.

When it is determined in the step S42 that the output Wa of the wind turbine generator 2 is not greater than the target output W_{T} and it is determined in the step S46 that both of the deterioration levels Ba and Bb are below the third thresholds B_{T} and B_{S}, the process advances to a step S52 to discharge from the secondary battery 10 under the control by the overall control unit 48. Such control corresponds to Wa≦W_{T} of Case 1 in FIG. 5 that is described above.

When it is determined, in the step S42 that the output Wa of the wind turbine generator 2 is not greater than the target output W_{T} and it is determined in the step S46 that at least one of the deterioration levels Ba and Bb is not less that the third thresholds B_{T} and B_{S}, the process advances to a step S54 to perform recovering of the rotation energy with higher priority under the control by the overall control unit 48. Such control corresponds to Wa≦W_{T} of Case 2 in FIG. 5 that is described above.

Further, after the steps of the battery-priority operation mode, S28, S32, S43 and S52 and after the steps of the rotation-energy-priority mode, S30, S34, S50 and S54, it is possible to provide a step of obtaining a frequency of the grid to which the wind turbine generator 2 and the secondary battery 10 are connected by a frequency sensor 17 and a step of modifying the target output so as to reduce the target output W when the frequency exceeds an upper limit of a prescribed range set beforehand or to increase the target output W_{T} when the frequency becomes lower than the lower limit of the prescribed range. In this manner, it is possible to keep the frequency of the grid 6 within the prescribed range.

According to the preferred embodiment, the achievement rate calculation unit 45 calculates the target-output achievement rate Ta from the measured output Wa or the wind turbine generator 2 measured by the output measuring unit 15, and the operation mode selection unit 42 selects the pitch-control invalid operation mode when the achievement rate is below the first threshold set beforehand. In such case, in order to reduce the surplus output Δ P of the wind turbine generator with respect to the target output, a pitch control is invalid and at least one of charging in the secondary battery 10 and storing rotation energy of the wind turbine generator 2 is performed, thereby performing the pitch control to feather the blades less often. As a result, the amount of wind energy lost without being converted into electric energy is reduced, thereby generating more electrical energy.

In the pitch-control permitted operation mode, the pitch control is permitted to reduce the surplus output of the wind turbine generator 2. Thus, depending on the state of the secondary battery 10, charging of the surplus output of the wind turbine generator 2 into the secondary battery may be avoided and instead the pitch control may be performed to reduce the number of times of charging into the secondary battery 10, thereby extending the life of the secondary battery 10.

Even if the target output achievement rate Ta at a point exceeds the first threshold T_{T} and there is comparatively sufficient power production, the wind speed and the wind direction changes and thus, it does not assure the power production can be kept positively after achieving the threshold once in order to achieve the target output. Therefore, when the loss rate La calculated by the loss rate calculation unit 43 is not less than the second threshold L_{T}, even if the production target achievement rate Ta is not less than the first threshold T_{T} and the pitch-control permitted operation mode is selected, the operation mode is switched to the pitch-control invalid mode by the operation mode selection unit 42, thereby performing the pitch control for reducing the surplus output of the wind turbine generator 2 less frequently. Thus, it is easy to achieve the target output in the set period of time.

The battery state detection unit 31 obtains the deterioration levels Ba and Bb of the secondary battery 10. The obtained deterioration levels Ba and Bb are compared with the third thresholds B_{T} and B_{S} that are set in advance. When at least one of the deterioration levels Ba and Bb is not less than the third thresholds B_{T} and B_{S}, storing or discharging of the rotation energy of the wind turbine generator 2 is performed with higher priority than charging or discharging of the secondary battery 10 so as to reduce the number of times that the secondary battery 10 is charged. In this manner, it is possible to prevent the life of the secondary battery 10 from decreasing.

While the present invention has been described with reference to exemplary embodiments, it is obvious to those skilled in the art, that various changes may be made without departing from the scope of the invention.

For instance, in the above preferred embodiment, the target output W_{T} of the wind turbine generator facility 1 is temporarily increased or decreased based on the frequency of the grid 7 obtained by the sensor 17. However, this is not limitative and the target output W_{T} of wind turbine generator facility 1 may be modified temporarily based on the deterioration levels Ba and Bb of the secondary battery 10. Specifically, when at least one of the deterioration levels Ba and Bb detected by the battery state detection unit 31 is not less than the third thresholds B_{T} and B_{S}, the target output W_{T} may be temporarily modified to reduce the difference between the output of the wind turbine generator 2 and the target output. In this manner, it is possible to sufficiently perform leveling of the power output more often by a method other than charging and discharging of the secondary batter (mainly by storing and discharging of the rotation energy of the wind turbine generator 2). As a result, it is possible to reduce the number of times that the secondary battery 10 is charged or discharged, thereby extending the life of the secondary battery 10.

In the above preferred embodiment, which one of storing/discharging of rotation energy of the wind turbine generator 2 and charging/discharging of the secondary battery 10 is performed with higher priority, is switched based on the result of comparing the deterioration levels Ba and Bb and the third thresholds B_{T} and B_{S}. However, this is not limitative and which one of storing/discharging of rotation energy of the wind turbine generator 2 and charging/discharging of the secondary battery 10 is performed with higher priority, may be switched based on a remaining capacity of the secondary battery 10 (SOC) in replacement of or in addition to the deterioration levels Ba and Bb. For instance, battery state detection unit 31 detects the remaining capacity of the secondary battery 10 in addition to the deterioration levels Ba and Bb and the battery state monitoring unit 32 determines whether or not the remaining capacity is within a prescribed range. When the remaining, capacity of the secondary battery 10 is not in the prescribed range, charging and discharging of the secondary battery is performed with higher priority by the overall control unit 48 to level the power output, thereby keeping the remaining capacity within the prescribed range.

Specifically, in the above preferred embodiment, in CASE 2 of FIG. 5 where Wa≦W_{T} and in Case 4 of FIG. 5 where Wa [symbol] _{T} and Wa≦W_{T}, in order to level the power output of the wind turbine generator facility 1, the rotation energy is stored or recovered and then, if there is still difference between the output Wa of the wind turbine generator 2 and the target output W_{T}, the secondary battery is charged or discharged. However, this is not limitative and it is also possible to charge or discharge the secondary battery 10 with higher priority when the remaining capacity of the secondary battery 10 is not within the prescribed range, so as to keep the remaining capacity within the prescribed range. In this manner, it is possible to extend the life of the secondary battery 10.

In the above preferred embodiment, the target-output achievement rate Ta obtained by the achievement rate calculation unit 45 is used when the operation mode selection unit 42 selects an operation mode. However, this is not limitative and the loss rate La obtained by the loss rate calculation unit 43 may be used to select an operation mode. Specifically, the steps S12 and S14 of FIG. 6 are replaced by the steps S17 and S18 of FIG. 6. First, the loss rate La is compared with the second threshold L_{T}. When La≧L_{T}, the pitch-control invalid operation mode is selected (S16). On the other hand, when La<L_{T}, the target-output achievement rate Ta is compared with the first threshold T_{T}. When Ta<T_{T}, the pitch-control invalid operation mode is selected (S16), whereas, when Ta≧T_{T}, the pitch-control permitted operation mode is selected (S19).

In the above preferred embodiment, the wind turbine generator facility 1 includes one wind turbine generator 2. However, the number of wind turbine generators 2 should not be limited and the wind turbine generator facility 1 may include more than one wind turbine generator 2.

### REFERENCE SIGNS LIST

1 Wind turbine generator facility
2 Wind turbine generator
3 Electrical power storage device
4 Power output leveling apparatus
5 Grid interconnecting part
6 Grid
8 Transformer
9 Generator
10 Secondary battery
11 DC-AC converter
12 Transformer
13 Transformer
14 Inverter unit
15 Output measuring unit
17 Sensor
18A Generator-side inverter
18B DC bus
20 Wind turbine controller
22 Difference calculation unit
24 Rotation energy monitoring unit
25 Rotation energy control unit
26 Pitch controller
30 Battery controller
31 Battery state detection unit
32 Battery state monitoring unit
33 Battery control unit
34 First switch
35, 36 Second switch
37 Third switch
38 Comparison unit
39 Subtractor
40 Master controller
41 Achievement rate monitoring unit
42 Operation mode selection unit
43 Loss rate calculation unit
44 Loss rate monitoring unit
45 Achievement rate calculation unit
46 Grid monitoring unit
48 Overall control unit
51 Adder
52 Rotor
52A Hub
52B Blade
SC Stator winding
RC Rotor winding

1. A power output leveling method for adjusting an output of a wind turbine generator facility in which a wind turbine generator is combined with a secondary battery to a target output, the method comprising the steps of:
measuring an output of the wind turbine generator;
calculating a target-output achievement rate that is a rate of an integrated value of the measured outputs of the wind turbine generator from a starting point of a set period of time to a prescribed point within the set period of time with respect to a target output in the set period of time; and
selecting an operation mode of the wind power facility,
wherein, in the step of selecting the operation mode, when the target-output achievement rate is below a first threshold, a pitch-control invalid operation mode is selected, in said pitch-control invalid operation mode a pitch control for leveling the output to reduce surplus output of the wind turbine generator with respect to the target output being invalid and at least one of charging in the secondary battery and storing rotation energy of the wind turbine generator being performed.

2. The power output leveling method for the wind turbine generator facility according to claim 1,
wherein, in the step of selecting the operation mode, when the target-output achievement rate is not less than the first threshold, a pitch-control permitted operation mode is selected, in said pitch-control permitted operation mode the pitch control being performed to reduce the surplus output of the wind turbine generator with respect to the target output.

3. The power output leveling method for the wind turbine generator facility according to claim 2, further comprising the step of:
when the pitch-control permitted operation mode is selected in the operation mode selecting step, calculating a loss rate that is a rate of an amount of power loss due to the pitch control to an ideal output that is obtained based on a wind speed according to a performance curve of the wind turbine generator representing a relationship between the wind speed and the ideal output of the wind turbine generator,
wherein, when the calculated loss rate is not less than a second threshold, the operation mode is switched from the pitch-control permitted operation mode to the pitch-control invalid operation mode.

4. The power output leveling method for the wind turbine generator facility according to claim 1, further comprising the step of:
obtaining a deterioration level of the secondary battery,
wherein, when the obtained deterioration level of the secondary battery exceeds a third threshold, charging and discharging of the rotation energy of the wind turbine generator is performed with higher priority than charging and discharging of the secondary battery, so as to reduce the surplus output or supply insufficient output with respect to the target output.

5. The power output leveling method for the wind turbine generator facility according to claim 4,
wherein, the deterioration level of the secondary battery is at least one of the number of charge-discharge cycles, the number of total charge-discharge cycles and the number of charge-discharge rates.

6. The power output leveling method for the wind turbine generator facility according to claim 1, further comprising the step of:
obtaining a remaining capacity of the secondary battery,
wherein, when the obtained remaining capacity of the secondary battery is not in a set range, charging and discharging of the secondary battery is performed with higher priority than charging and discharging of the rotation energy of the wind turbine generator, so as to reduce the surplus output or supply insufficient output with respect to the target output.

7. The power output leveling method for the wind turbine generator facility according to claim 4, further comprising:
a first target output modifying step of modifying the target output temporarily so as to reduce a difference between the output of the wind, turbine generator and the target output, when the obtained deterioration level, of the secondary battery exceeds the third threshold.

8. The power output leveling method for the wind turbine generator facility according to claim 1, further comprising:
a second target output modifying step of increasing the target output when the target-output achievement rate is less than the first threshold.

9. The power output leveling method for the wind turbine generator facility according to claim 1, further comprising:
a step of obtaining a frequency of a grid to which the wind turbine generator and the secondary battery are connected; and
a third target output modifying step of reducing the target output when the obtained frequency exceeds a set upper limit whereas increasing the target output when the obtained frequency becomes less than a set lower limit.

10. A power output leveling apparatus of adjusting an output of a wind turbine generator facility in which a secondary battery is combined a wind turbine generator to a target output, the apparatus comprising:
an output measuring unit which measures an output of the wind turbine generator;
a calculation unit which calculates a target-output achievement rate that is a rate of an integrated value of the measured outputs of the wind turbine generator from a starting point of a set period of time to a prescribed point, within the set period of time with respect to a target output in the set period of time; and
an operation mode selection unit which selects a pitch-control invalid operation mode when the target-output achievement rate is below a first threshold, in said pitch-control invalid operation mode a pitch control for leveling the output to reduce surplus output of the wind turbine generator with respect to the target output being invalid and at least one of charging into the secondary battery and storing rotation energy of the wind turbine generator being performed.

11. A power output leveling method for adjusting an output of a wind turbine generator facility in which a secondary battery is combined with a wind turbine generator to a target output, the method comprising the steps of:
measuring an output of the wind turbine generator;
calculating a loss rate that is a rate of an amount of power loss due to the pitch control to an ideal output that, is obtained based on a wind speed according to a performance curve of the wind turbine generator representing a relationship between the wind speed and the ideal output of the wind turbine generator; and
selecting an operation mode of the wind power facility,
wherein, in the step of selecting the operation mode, when the loss rate is below a second threshold, a pitch-control invalid operation mode is selected, in said pitch-control invalid operation a pitch control for leveling the output to reduce surplus output of the wind turbine generator with respect to the target output being invalid and at least one of charging into the secondary battery and storing rotation energy of the wind turbine generator being performed.
